(19) United States
(12) Patent Application Publication
(10) Pub. No.: US 2021/0269581 A1
(43) Pub. Date: Sep. 2, 2021

(54) ELASTOMERIC POLYURETHANE FOAMS AND METHODS FOR PRODUCING THE SAME

(71) Applicant: BASF SE, Ludwigshafen am Rhein (DE)

(72) Inventors: Michael Fritz, Wyandotte, MI (US); David Dean Peters, Wyandotte, MI (US); Janine Luesing, Wyandotte, MI (US)

(21) Appl. No.: 17/258,242

(22) PCT Filed: Jul. 8, 2019
(86) PCT No.: PCT/US2019/040767

§ 371 Date: Jan. 6, 2021

Related U.S. Application Data
(60) Provisional application No. 62/694,704, filed on Jul. 6, 2018.

(51) Int. Cl. C08G 18/80; C08G 18/10; C08G 18/76; C08G 18/32; C08G 18/48; C08G 18/66

(52) U.S. Cl. CPC C08G 18/8029; C08G 18/10; C08G 18/7664; C08G 18/3206; C08G 18/4812; C08G 2340/00; C08G 18/4845; C08G 18/6674; C08G 2110/0008; C08G 2110/0066; C08G 2110/0083; C08G 18/4841

(57) ABSTRACT

Embodiments of the present disclosure includes an elastomeric polyurethane foam with improved high temperature performance, comprising a reaction product of components including: (a) an isocyanate functional urethane prepolymer derived from one or more prepolymers comprising monomeric diphenylmethane diisocyanate (MDI) and polymeric MDI, and a polyether diol; and (b) an isocyanate-reactive component including: (i) a first polyol in an amount of about 10 to about 70 parts by weight of the isocyanate-reactive component, wherein the first polyol is a propylene oxide or ethylene oxide-capped nominal diol with a number-average molecular weight between about 1000 g/mol and about 9000 g/mol; (ii) a second polyol in an amount of about 0 to about 50 parts by weight of the isocyanate-reactive component, wherein the second polyol is a nominal triol with a high proportion of randomly dispersed ethoxy groups with a number-average molecular weight between about 1000 g/mol and about 8000 g/mol; (iii) a third polyol in an amount of about 0 to about 20 parts by weight of the isocyanate-reactive component, wherein the third polyol is an ethylene oxide-capped nominal tetraol with a number-average molecular weight between about 250 g/mol and about 6000 g/mol; and (iv) a fourth polyol in an amount of about 0 to about 80 parts by weight of the isocyanate-reactive component, wherein the fourth polyol is an ethylene oxide or propylene oxide-capped nominal triol with a number-average molecular weight between about 1000 g/mol and about 13000 g/mol. In one another embodiment, the isocyanate-reactive component also includes an additive package in the amount of about 1 to about 30 that can contain, but is not limited to, blowing agents, catalysts, coloring agents, inorganic filler, and anti-oxidants.

### FIELD OF THE INVENTION

The present application relates generally to elastomeric polyurethane foams having improved high-temperature performance and methods for producing such elastomeric polyurethane foams.

### BACKGROUND OF THE INVENTION

Elastomeric polyurethane foams are commonly used to manufacture many materials that required elevated temperature applications, like air filter gaskets, filter seals, filter endcaps, and engine covers used in internal combustion engines. The trend to improve automotive engine performance has resulted in higher temperatures in the engine compartment. This increase in temperature has led to the need for materials that are more resistant to prolonged exposure at elevated temperatures.

Therefore, elastomeric polyurethane foams with improved high temperature performance are needed, wherein such foams can be manufactured using existing manufacturing processes and readily available raw materials.

### SUMMARY OF THE INVENTION

Embodiments of the present disclosure include an elastomeric polyurethane foam with improved high temperature performance, wherein such foam comprises a reaction product of components including, but not limited to: (a) an isocyanate functional urethane prepolymer derived from one or more prepolymers comprising monomeric diphenylmethane diisocyanate (MMDI) and polymeric MDI (PMDI), and a polyether diol; and (b) an isocyanate-reactive component including: (i) a first polyol in an amount of about 10 to about 70 parts by weight of the isocyanate-reactive component, wherein the first polyol is propylene oxide or ethylene oxide-capped nominal diol with a number-average molecular weight between about 1000 g/mol and about 9000 g/mol; (ii) a second polyol in an amount of about 0 to about 50 parts by weight of the isocyanate-reactive component, wherein the second polyol comprises a nominal triol with a high proportion of randomly dispersed ethoxy groups with a number-average molecular weight between about 1000 g/mol and about 8000 g/mol; (iii) a third polyol in an amount of about 0 to about 20 parts by weight of the isocyanate-reactive component, wherein the third polyol comprises an ethylene oxide-capped nominal tetraol with a number-average molecular weight between about 250 g/mol to about 6000 g/mol; and (iv) a fourth polyol in an amount of about 0 to about 80 parts by weight of the isocyanate-reactive component, wherein the fourth polyol is an ethylene oxide or propylene oxide-capped nominal triol with a number-average molecular weight between about 1000 g/mol and about 13000 g/mol; wherein at least one of components (ii), (iii), and (iv) are present at more than about 0 parts by weight.

In one embodiment, the first polyol comprises about 30 to about 70 parts by weight of the isocyanate-reactive component. In another embodiment, the first polyol comprises about 35 to about 65 parts by weight of the isocyanate-reactive component. In a specific embodiment, the first polyol has a number-average molecular weight of about 6000 g/mol and a functionality of 1.5 to 2.0.

In one embodiment, the second polyol comprises about 0 to about 45 parts by weight of the isocyanate-reactive component. In another embodiment, the second polyol comprises about 15 to about 40 parts by weight of the isocyanate-reactive component. In a specific embodiment, the second polyol has a number-average molecular weight of about 3600 g/mol and a functionality of 2.8 to 3.0.

In one embodiment, the third polyol comprises about 0 to about 15 parts by weight of the isocyanate-reactive component. In another embodiment, the third polyol comprises about 0 to about 10 parts by weight of the isocyanate-reactive component. In a specific embodiment, the third polyol has a number-average molecular weight of about 5250 g/mol and a functionality of 3.5 to 5.0.

In one embodiment, the fourth polyol comprises about 0 to about 30 parts by weight of the isocyanate-reactive component. In another embodiment, the fourth polyol comprises about 0 to about 15 parts by weight of the isocyanate-reactive component. In a specific embodiment, the fourth polyol has a number-average molecular weight of about 2800 to 6000 g/mol and a functionality of 2.1 to 3.0.

In one embodiment, the isocyanate-reactive component further includes an additive package in an amount of about 1 to about 30 parts by weight of the isocyanate-reactive component. The additive package comprises components selected from those classified by ones skilled in the art as blowing agents, catalysts, coloring agents, dyes, pigments, cross-linkers, flame retardant, diluents, solvents, an inorganic filler, surfactants, inorganic fillers, anti-oxidants ultraviolet stabilizers, biocides, adhesion promoters, antistatic agents, mold release agents, fragrances and any combination thereof. The blowing agent may be a chemical blowing agent in an amount of about 0.1 to about 4 parts by weight of the isocyanate-reactive component. The blowing agent may also be a physical blowing agent in an amount of about 0 to 12 parts by weight of the isocyanate reactive component. The chemical blowing agent may be, but not limited to, water. The physical blowing agent can be, but is not limited to, HCFO-1233zd(E).

In another embodiment, the isocyanate-reactive component may include a surfactant in the amount of about 0 to about 6 or even about 5 parts by weight of isocyanate-reactive component. In a specific embodiment, the surfactant may be Dabco® DC5000 or chemically equivalent alternative available under a different trade name. In an additional embodiment, the isocyanate-reactive component may include a chain extender in an amount of about 0 to about 10 parts by weight of the isocyanate-reactive component. In a specific embodiment, the chain extender may be 1,4-butanediol (BDO).

In one embodiment, the MMDI used to produce the isocyanate functional urethane prepolymer is in an amount of about 20 to about 70 parts, the MMDI is at least 97 wt % 4,4′-MDI. In another embodiment, the PMDI used to produce the isocyanate functional urethane prepolymer is in an amount of about 20 to about 70 parts, the PMDI has a viscosity from about 150 to about 850 cps at 25° C. and a percent NCO from about 30 to about 32.5. In yet another embodiment, the polyether diol used to produce the isocyanate functional urethane prepolymer is in an amount of about 5 to about 30 parts, the polyether diol has a number-average molecular weight of about 425 g/mol to about 6000 g/mol and a functionality of 1.2 to 2.0. In a further embodiment the polyether diol has a number-average molecular weight of about 425 g/mol and a functionality of 1.75 to 2.0 or a number-average molecular weight of about 6000 g/mol and a functionality of 1.5 to 2.0. In a specific embodiment, the MMDI is Lupranate® M, the PMDI is Lupranate® M20, and the polyether diol is Pluracol® 410 or Pluracol®1062.

In one embodiment, more than one prepolymers may be used to produce the isocyanate functional urethane prepolymer. In some embodiments, for example, a first prepolymer may comprise MMDI, and a second prepolymer may comprise a polyether prepolymer. The ratios of the prepolymers may vary according to the desired properties of the end product, i.e. the improved elastomeric polyurethane foam of the invention. In certain embodiments, the ratio of a first and second prepolymer used to produce the isocyanate functional urethane prepolymer may comprise a ratio (on a weight basis) of 99:1 to 50:50, or from 99:1 to 70:30, 80:30, or 90:10. In some embodiments the ratios may vary from 80:20 to 60:40, or from 75:25 to 65:35, or 70:30. In some embodiments, the first prepolymer is present in an amount of 50% of more in comparison to the second prepolymer.

In one embodiment, the constant deflection compression set value at 40% deflection of the elastomeric polyurethane foam in the instant disclosure according to ASTM D3574 is less than about 40% when the foam sample is compressed at about 70° C. to about 150° C. for about 22 to about 100 hours. In another embodiment, the constant deflection compression set value at about 30% to about 50% deflection of the elastomeric polyurethane foam in the instant disclosure according to ASTM D3574 is less than about 40% when the foam sample is compressed at about 100° C. to about 130° C. for about 22 to about 100 hours.

In one embodiment, the tensile strength value of the elastomeric polyurethane foam in the instant disclosure according to ASTM D3574 is about 50 lbf/in² to about 285 lbf/in². In another embodiment, the tear strength value of the elastomeric polyurethane foam in the instant disclosure according to ASTM D3574 is about 13 lbf/in to about 40 lbf/in. In yet another embodiment, the elongation at break value of the elastomeric polyurethane foam in the instant disclosure according to ASTM D3574 is about 50% to about 160%.

In one embodiment, the tensile strength value of the elastomeric polyurethane foam in the instant disclosure according to ASTM D3574 undergoes about less than 50% change when the foam is aged at about 102° C. for about 70 hours. In another embodiment, the tear strength value of the elastomeric polyurethane foam in the instant disclosure according to ASTM D3574 undergoes about less than 30% change when the foam is aged at about 102° C. for about 70 hours. In yet another embodiment, the elongation at break value of the elastomeric polyurethane foam in the instant disclosure according to ASTM D3574 undergoes about less than 50% change when the foam is aged at about 102° C. for about 70 hours.

In one embodiment, the tensile strength value of the elastomeric polyurethane foam in the instant disclosure according to ASTM D3574 undergoes about less than 35% change when the foam is aged at about 60° C. and about 95% relative humidity for about 168 hours. In another embodiment, the tear strength value of the elastomeric polyurethane foam in the instant disclosure according to ASTM D3574 undergoes about less than 35% change when the foam is aged at about 60° C. and about 95% relative humidity for about 168 hours. In yet another embodiment, the elongation at break value of the elastomeric polyurethane foam in the instant disclosure according to ASTM D3574 undergoes about less than 35% change when the foam is aged at about 60° C. and about 95% relative humidity for about 168 hours.

Also disclosed is a method of forming an elastomeric polyurethane foam, the method includes reacting a MMDI and a PMDI with a polyether diol to form an isocyanate functional urethane prepolymer; blending at least a first polyol, a second polyol, a third polyol, and a fourth polyol to form an isocyanate-reactive component; and mixing the isocyanate prepolymer and the isocyanate-reactive component at about 100 isocyanate index to about 110 isocyanate index to form the elastomeric polyurethane foam, wherein the first polyol is a propylene oxide or ethylene oxide-capped nominal diol with a number-average molecular weight between about 1000 g/mol and about 9000 g/mol that comprises about 10 to about 70 parts by weight of the isocyanate-reactive component; the second polyol is a nominal triol that has a high proportion of randomly dispersed ethoxy groups with a number-average molecular weight between about 1000 g/mol and about 8000 g/mol and comprises about 0 to about 50 parts by weight of the isocyanate-reactive component; the third polyol is an ethylene oxide-capped nominal tetraol with a number-average molecular weight between about 250 g/mol and about 6000 g/mol and comprises about 0 to about 15 parts by weight of the isocyanate-reactive component; the fourth polyol is an ethylene oxide or propylene oxide-capped nominal triol with a number-average molecular weight of about 1000 g/mol and about 13000 g/mol and comprises about 0 to about 80 parts by weight of the isocyanate-reactive component.

Other features and advantages can become apparent from the following detailed description.

### DETAILED DESCRIPTION OF THE INVENTION

The elastomeric polyurethane foam of the present disclosure comprises the reaction product of an isocyanate component and an isocyanate-reactive component. It is to be appreciated that the terminology “isocyanate component” as used herein, is not limited to monomeric diphenylmethane diisocyanate (MMDI), i.e., the isocyanate component may comprise MMDI and polymeric polyisocyanates (PMDI). In addition, the terminology “isocyanate component” as used herein, encompasses isocyanate terminated quasi-prepolymers, or those materials commonly referred to as prepolymers. In a specific embodiment, prepolymers, e.g. polyols reacted with excess isocyanate, may be utilized as the isocyanate component in the present disclosure. The isocyanate component may include, but is not limited to, 4,4′-MDI, 2,4′-MDI, PMDI, prepolymers constructed from 4,4′-MDI, 2,4′-MDI, PMDI, carbodiimide modified isocyanates, biuret modified isocyanates, allophanate modified isocyanates and combinations thereof. In one embodiment, the isocyanate component includes an n-functional isocyanate, wherein “n” may be a number from 2 to 5, from 2 to 4, or from 3 to 4. It is to be understood that “n” may be an integer or may have intermediate values from 2 to 5. The isocyanate component may also include an isocyanate selected from the group of aromatic isocyanates, aliphatic isocyanates, and combinations thereof. In another embodiment, the isocyanate component includes an aliphatic isocyanate such as hexamethylene diisocyanate, H12MDI, and combinations thereof. If the isocyanate component includes an aliphatic isocyanate, the isocyanate component may also include a modified multivalent aliphatic isocyanate, i.e., a product which is obtained through chemical reactions of aliphatic diisocyanates and/or aliphatic polyisocyanates. Examples include, but are not limited to, ureas, biurets, allophanates, carbodiimides, uretonimines, isocyanurates, urethane groups, dimers, trimers, and combinations thereof. The isocyanate component may also include, but is not limited to, modified diisocyanates employed individually or in reaction products with polyoxyalkyleneglycols, diethylene glycols, dipropylene glycols, polyoxyethylene glycols, polyoxypropylene glycols, polyoxypropylenepolyoxethylene glycols, polyesterols, polycaprolactones, and combinations thereof.

Alternatively, the isocyanate component may include an aromatic isocyanate. If the isocyanate component includes an aromatic isocyanate, the aromatic isocyanate may correspond to the formula R′(NCO)_{z} wherein R′ is aromatic and z is an integer that corresponds to the valence of R′. Preferably, z is at least two. Suitable examples of aromatic isocyanates include, but are not limited to, tetramethylxylylene diisocyanate (TMXDI), 1,4-diisocyanatobenzene, 1,3-diisocyanato-o-xylene, 1,3-diisocyanato-p-xylene, 1,3-diisocyanato-m-xylene, 2,4-diisocyanato-1-chlorobenzene, 2,4-diisocyanato-1-nitro-benzene, 2,5-diisocyanato-1-nitrobenzene, m-phenylene diisocyanate, p-phenylene diisocyanate, 2,4-toluene diisocyanate, 2,6-toluene diisocyanate, mixtures of 2,4- and 2,6-toluene diisocyanate, 1,5-naphthalene diisocyanate, 1-methoxy-2,4-phenylene diisocyanate, 4,4′-diphenylmethane diisocyanate, 2,4′-diphenylmethane diisocyanate, 4,4′-biphenylene diisocyanate, 3,3′-dimethyl-4,4′-diphenylmethane diisocyanate, 3,3′-dimethyldiphenylmethane-4,4′-diisocyanate, triisocyanates such as 4,4′,4″-triphenylmethane triisocyanate polymethylene polyphenylene polyisocyanate and 2,4,6-toluene triisocyanate, tetraisocyanates such as 4,4′-dimethyl-2,2′-5,5′-diphenylmethane tetraisocyanate, toluene diisocyanate, 2,2′-diphenylmethane diisocyanate, 2,4′-diphenylmethane diisocyanate, 4,4′-diphenylmethane diisocyanate, polymethylene polyphenylene polyisocyanate, corresponding isomeric mixtures thereof, and combinations thereof. Alternatively, the aromatic isocyanate may include a triisocyanate product of m-TMXDI and 1,1,1-trimethylolpropane, a reaction product of toluene diisocyanate and 1,1,1-trimethyolpropane, and combinations thereof. In one embodiment, the isocyanate component includes a diisocyanate selected from the group of methylene diphenyl diisocyanates, toluene diisocyanates, hexamethylene diisocyanates, H12MDIs, and combinations thereof.

The isocyanate component used to prepare the prepolymer may have any percent NCO content and any viscosity. Some non-limiting percent NCO values can be about 1 to about 60, about 5 to about 50, about 10 to about 40, about 20 to about 35, about 30 to about 60, about 1 to about 32.5, or about 30 to about 32.5. The isocyanate component used to prepare the prepolymer can include a MMDI, a PMDI, and a combination thereof. Some non-limiting viscosity values of the isocyanate at 25° C. are about 0 to about 8000 cps, about 0 to about 5000 cps, about 50 to about 4000 cps, about 100 to about 3000 cps, about 120 to about 1500 cps, about 150 to about 5000 cps, about 0 to about 850 cps, or about 150 to about 850 cps. The isocyanate component may also react with polyol and/or chain extender in any amount, as determined by one skilled in the art. In a specific embodiment, the isocyanates used in this disclosure can be under the trade names Lupranate® M and/or Lupranate® M20.

The prepolymer is then used to prepare the urethane foam, wherein the prepolymer may have any percent NCO content and any viscosity. The prepolymer component may also react with the resin and/or chain extender in any amount, as determined by one skilled in the art. Preferably, the isocyanate component and the resin and/or chain extender are reacted at an isocyanate index from about 95 to about 130, or from about 100 to about 115. Isocyanate index is a ratio of an actual molar amount of isocyanate(s) reacted with the polyol(s) to a stoichiometric molar amount of isocyanate(s) needed to react with an equivalent molar amount of the polyol(s). In one embodiment, commercially available isocyanates can be used.

In one embodiment, more than one prepolymer may be used to produce the isocyanate functional urethane prepolymer. In some embodiments, for example, a first prepolymer may comprise MMDI, and a second prepolymer may comprise a polyether prepolymer. In another example, the isocyanate functional urethane prepolymer may comprise a PMDI/MMDI-P410 prepolymer (e.g. Elastofoam 24050T) and a polyether prepolymer, such as MMDI-P410/DEG prepolymer (e.g. Elastofoam MP102). The ratios of the prepolymers may vary according to the desired properties of the end product, i.e. heat resistance of the improved elastomeric polyurethane foam of the invention. In certain embodiments, the ratio of a first and second prepolymer used to produce the isocyanate functional urethane prepolymer may comprise a ratio (on a weight basis) of 99:1 to 50:50, or from 99:1 to 70:30, 80:30, or 90:10. In some embodiments the ratios may vary from 80:20 to 60:40, or from 75:25 to 65:35, or 70:30. In some embodiments, the first prepolymer is present in an amount of 50% of more in comparison to the second prepolymer.

The isocyanate-reactive component of the present disclosure may include one or more of a polyether polyol, a polyester polyol, and combinations thereof. As is known in the art, polyether polyols are typically formed from a reaction of an initiator and an alkylene oxide. Preferably, the initiator is selected from the group of aliphatic initiators, aromatic initiators, and combinations thereof. In one embodiment, the initiator is selected from the group of ethylene glycol, propylene glycol, dipropylene glycol, butylene glycol, trimethylene glycol, 1,2-butanediol, 1,3-butanediol, 1,4-butanediol, 1,2-pentanediol, 1,4-pentanediol, 1,5-pentanediol, 1,6-hexanediol, 1,7-heptanediol, butenediol, butynediol, xylylene glycols, amylene glycols, 1,4-phenylene-bis-beta-hydroxy ethyl ether, 1,3-phenylene-bis-beta-hydroxy ethyl ether, bis-(hydroxy-methyl-cyclohexane), thiodiglycol, glycerol, 1,1,1-trimethylolpropane, 1,1,1-trimethylolethane, 1,2,6-hexanetriol, .alpha.-methyl glucoside, pentaerythritol, sorbitol, aniline, o-chloroaniline, p-aminoaniline, 1,5-diaminonaphthalene, methylene dianiline, the condensation products of aniline and formaldehyde, 2,3-, 2,6-, 3,4-, 2,5-, and 2,4-diaminotoluene and isomeric mixtures, methylamine, triisopropanolamine, ethylenediamine, 1,3-diaminopropane, 1,3-diaminobutane, 1,4-diaminobutane, propylene diamine, butylene diamine, hexamethylene diamine, cyclohexalene diamine, phenylene diamine, tolylene diamine, xylylene diamine, 3,3′-dichlorobenzidine, 3,3′- and dinitrobenzidine, alkanol amines including ethanol amine, aminopropyl alcohol, 2,2-dimethyl propanol amine, 3-aminocyclohexyl alcohol, and p-aminobenzyl alcohol, and combinations thereof. It is contemplated that any suitable initiator known in the art may be used in the present disclosure.

Preferably, the alkylene oxide that reacts with the initiator to form the polyether polyol is selected from the group of ethylene oxide, propylene oxide, butylene oxide, amylene oxide, tetrahydrofuran, alkylene oxide-tetrahydrofuran mixtures, epihalohydrins, aralkylene oxides, and combinations thereof. More preferably, the alkylene oxide is selected from the group of ethylene oxide, propylene oxide, and combinations thereof. Most preferably, the alkylene oxide includes ethylene oxide. However, it is also contemplated that any suitable alkylene oxide that is known in the art may be used in the present disclosure.

The polyether polyol may include an ethylene oxide cap of from about 3 to about 25% by weight based on the total weight of the polyether polyol. Without intending to be bound by any particular theory, it is believed that the ethylene oxide cap promotes an increase in a rate of the reaction of the polyether polyol and the isocyanate. In some embodiment, ethylene oxide is randomly distributed throughout the polymer chain of the polyol with a percentage of about 1 to about 90, or even about 3 to about 75 mole percent ethylene oxide.

The polyether polyol may include a propylene oxide cap of from about 3 to about 25% by weight based on the total weight of the polyether polyol. In other embodiment, polyether polyol may be compose solely of propylene oxide as the alkoxylating agent. Without intending to be bound by any particular theory, it is believed that the propylene oxide cap decreases the rate of the reaction of the polyether polyol and the isocyanate. In some embodiment, the propylene oxide-capped polyol contains randomly distributed ethylene oxide in the polymer chain of the polyol with a percentage of about 2 to 25 or even from about 2 to 15 mole percent ethylene oxide.

The polyether polyol may also have a number-average molecular weight of from 18 to 10,000 g/mol. Further, the polyether polyol may have a hydroxyl number of from 15 to 6,250 mg KOH/g. The polyether polyol may also have a nominal functionality of from 2 to 8. Further, further, the polyether polyol may also include an organic functional group selected from the group of a carboxyl group, an amine group, a carbamate group, an amide group, and an epoxy group.

Referring now to the polyester polyols introduced above, the polyester polyols may be polycaprolactone esters or produced from a reaction of a dicarboxylic acid and a glycol having at least one primary hydroxyl group. Suitable dicarboxylic acids may be selected from the group of, but are not limited to, adipic acid, methyl adipic acid, succinic acid, suberic acid, sebacic acid, oxalic acid, glutaric acid, pimelic acid, azelaic acid, phthalic acid, terephthalic acid, isophthalic acid, and combinations thereof. Suitable glycols include, but are not limited to, those described above.

The polyester polyol may also have a number-average molecular weight of from 80 to 1500 g/mol. Further, the polyester polyol may have a hydroxyl number of from 40 to 600 mg KOH/g. The polyester polyol may also have a nominal functionality of from 2 to 8. Further, further, the polyester polyol may also include an organic functional group selected from the group of a carboxyl group, an amine group, a carbamate group, an amide group, and an epoxy group.

The first polyol can have a number-average molecular weight of about 6000 g/mol and a functionality of 1.5 to 2.0. One non-limiting, representative example of a first polyol used for the isocyanate-reactive component in the instant disclosure is Pluracol® 1062 polyol, which is an ethylene oxide-capped nominal diol with a number-average molecular weight between about 1000 g/mol and about 9000 g/mol. Some non-limiting effective amounts of Pluracol® 1062 are from about 1 to about 99 parts by weight of the isocyanate-reactive component, from about 5 to about 90 parts, from about 10 to about 80 parts, from about 10 to about 70 parts, from about 20 to about 75 parts, from about 30 to about 70 parts, from about 35 to about 65 parts, from about 35 to about 99 parts, and from about 1 to about 65 parts.

The second polyol can have a number-average molecular weight of about 3600 g/mol and a functionality of 2.8 to 3.0. One non-limiting, representative example of a second polyol is Pluracol® 593 polyol, which is a nominal triol with a high proportion of randomly dispersed ethoxy groups with a number-average molecular weight between about 1000 g/mol and about 8000 g/mol. Some non-limiting effective amounts of Pluracol® 593 are from about 0 to about 99 parts by weight of the isocyanate-reactive component, from about 0 to about 90 parts, from about 0 to about 80 parts, from about 0 to about 70 parts, from about 0 to about 50 parts, from about 0 to about 45 parts, from about 15 to about 40 parts, from about 15 to about 99 parts, and from about 0 to about 40 parts.

The third polyol can have a number-average molecular weight of about 5250 g/mol and a functionality of 3.5 to 5.0. One non-limiting, representative example of a third polyol is Lupranol® 2010/1, which is an ethylene oxide-capped nominal tetraol with a number-average molecular weight between about 250 g/mol and about 6000 g/mol. Some non-limiting effective amounts of Lupranol® 2010/1 are from about 0 to about 99 parts by weight of the isocyanate-reactive component, from about 0 to about 90 parts, from about 0 to about 80 parts, from about 0 to about 70 parts, from about 0 to about 50 parts, from about 0 to about 20 parts, from about 0 to about 15 parts, and from about 0 to about 10 parts.

The fourth polyol can have a number-average molecular weight of about 2800 to 6000 g/mol and a functionality of 2.1 to 3.0. One non-limiting, representative example of a fourth polyol is Pluracol® 2097 polyol, which is an ethylene oxide-capped nominal triol with a number-average molecular weight between about 1000 g/mol and about 13000 g/mol. Some non-limiting effective amounts of Pluracol® 2097 polyol are from about 0 to about 99 parts by weight of the isocyanate-reactive component, from about 0 to about 90 parts, from about 0 to about 80 parts, from about 0 to about 70 parts, from about 0 to about 50 parts, from about 0 to about 30 parts, from about 0 to about 15 parts, from about 0 to about 10 parts, and from about 0 to about 5 parts.

Another non-limiting, representative example of the fourth polyol is Pluracol® 4156 polyol, which is a propylene oxide-capped nominal triol with a number-average molecular weight between about 1000 g/mol and about 13000 g/mol. Some non-limiting effective amounts of Pluracol® 4156 polyol are from about 0 to about 99 parts by weight of the isocyanate-reactive component, from about 0 to about 90 parts, from about 0 to about 80 parts, from about 0 to about 70 parts, from about 0 to about 50 parts, from about 0 to about 30 parts, from about 0 to about 15 parts, from about 0 to about 10 parts, and from about 0 to about 5 parts.

The elastomeric polyurethane foam in the present disclosure may also contain an additive component package. In a specific embodiment, the additive component can be used in the isocyanate-reactive component. The additive component can be selected from the group of, but not limited to, surfactants, catalyst blocking agents, blowing agents, coloring agents, dyes, pigments, cross-linkers, flame retardant, diluents, solvents, inorganic fillers, catalysts, specialized functional additives such as antioxidants, ultraviolet stabilizers, biocides, adhesion promoters, antistatic agents, mold release agents, fragrances, and combinations of these groups. When utilized, the additive component can be present in the isocyanate-reactive component in an amount of from greater than 1 to about 30, more typically from about 1 to about 20 parts by weight based on 100 parts of total polyol present in the isocyanate-reactive component.

Flame retardant additives can be used to produce elastomeric polyurethane foams exhibiting flame retardance. For example, flame retardant additives including minerals, such as aluminum trihydrate; salts, such as hydroxymethyl phosponium salts; phosphorous compounds; phosphated esters; and halocarbons or other halogenated compounds, such as those containing bromine and/or chlorine; can be included in the isocyanate-reactive component.

A cross-linking agent having a nominal functionality in the range of 3 to 6 can be used to produce the elastomeric polyurethane foam in the instant disclosure. In one embodiment, the cross-linking agent can be used in the isocyanate-reactive component. The cross-linking agent generally can allow phase separation between copolymer segments of the elastomeric polyurethane foam. That is, the elastomeric polyurethane foam typically comprises both rigid urea copolymer segments and soft polyol copolymer segments. The cross-linking agent typically chemically and physically links the rigid urea copolymer segments to the soft polyol copolymer segments. Therefore, the cross-linking agent is typically present in the isocyanate-reactive component to modify the hardness, increase stability, and reduce shrinkage of the elastomeric polyurethane foam. When utilized, the cross-linking agent can be present in the isocyanate-reactive component in an amount of from greater than zero to about 5, more typically from about 0.25 to about 3 parts by weight based on 100 parts by weight of total polyol present in the isocyanate-reactive component.

A catalyst component of the additive component can be used to produce the elastomeric polyurethane foam in the current disclosure. Exemplary catalysts include, but are not limited to, N,N-dimethylethanolamine (DMEA), N,N-dimethylcyclohexylamine (DMCHA), bis(N,N-dimethylaminoethyl)ether (BDMAFE), N,N,N′,N′,N″-pentamethyldiethylenetriamine (PDMAFE), 1,4-diazadicyclo[2,2,2]octane (DABCO), 2-(2-dimethylaminoethoxy)-ethanol (DMAFE), 2-((2-dimethylaminoethoxy)-ethyl methyl-amino)ethanol, 1-(bis(3-dimethylamino)-propyl)amino-2-propanol, N,N′,N″-tris(3-dimethylamino-propyl)hexahydrotriazine, dimorpholinodiethylether (DMDEE), N,N-dimethylbenzylamine, N,N,N′,N″,N″-pentaamethyldipropylenetriamine, N,N′-diethylpiperaztne, and etc. In particular, sterically hindered primary, secondary or tertiary amines can be used, including, but are not limited to, dicyclohexylmethylamine, ethyldiisopropylamine, dimethylcyclohexylamine, dimethylisopropylamine, methylisopropylbenzylamine, methylcyclopentylbenzylamine, isopropyl-sec-butyl-trifluoroethylamine, diethyl-(o-phenyethyl) amine, tri-n-propylamine, dicyclohexylamine, t-butylisopropylamine, di-t-butylamine, cyclohexyl-t-butylamine, de-sec-butylamine, dicyclopentylamine, di-(a-trifluoromethylethyl) amine, di-(a-phenylethyl) amine, triphenylmethylamine, and 1,1,-diethyl-n-propylamine. Other sterically hindered amines are morpholines, imidazoles, ether containing compounds such as dimorpholinodiethylether, N-ethylmorpholine, N-methylmorpholine, bis(dimethylaminoefhyl)ether, imidizole, n-methylimidazole, 1,2-dimethylimidazole. dimorpholinodimethylether, N,N,N,N′,N″,N″-pentamethyldiethylenetriamine, N,N,N′,N′,N″,N″-pentamethyldipropylenetriamine, bis(diethylaminoethyl)ether, bis(dimethylaminopropyl)ether, or combinations thereof. Non-amine catalysts include, but are not limited to, stannous octoate, dibutyltin dilaurate, dibutyltin mercaptide, phenylmercuric propionate, lead octoate, potassium acetate/octoate, quaternary ammonium formates, ferric acetylacetonate and mixtures thereof. The use level of the catalysts can be in an amount of about 0.05 to about 4.00 wt % of isocyanate-reactive component, from about 0.15 to about 3.60 wt %, or from about 0.40 to about 2.60 wt %. In a specific embodiment, the catalyst component can be present in the isocyanate-reactive component to catalyze the elastomeric polyurethane foaming reaction between the isocyanate component and the isocyanate-reactive component. It is to be appreciated that the catalyst component is typically not consumed to form the reaction product of the isocyanate component and the isocyanate-reactive component, but may contain active hydrogen groups that can react with the isocyanate groups. That is, the catalyst component typically participates in, but is not consumed by, the elastomeric polyurethane foaming reaction. The catalyst component may include any suitable catalyst or mixtures of catalysts known in the art. A suitable catalyst component for purposes of the present disclosure is Dabco® 8154 and Dabco® 1027, commercially available from Evonik Industries of Parsippany, N.J.

The additive component may further comprise a surfactant, which can be used to control cell structure of the elastomeric polyurethane foam, impact the surface structure of the elastomeric polyurethane foam and to improve miscibility of components in the isocyanate-reactive component and the resultant elastomeric polyurethane foam stability. Suitable surfactants include any surfactant known in the art, such as silicones and nonylphenol ethoxylates. In one embodiment, the surfactant can be a polysilicone polymer. In a specific embodiment, the polysilicone polymer is a polydimethylsiloxane-polyoxyalkylene block copolymer. The surfactant can be selected according to the requirements of the isocyanate reactive component, if present in the isocyanate-reactive component. When utilized, the surfactant can be present in the isocyanate-reactive component in an amount of from about 0 to about 6, from about 0 to about 5, from about 0.5 to about 6, or even from about 0.5 to 5 parts by weight based on 100 parts by weight of total polyol present in the isocyanate-reactive component. A specific example of a surfactant for the purposes of the present disclosure is Dabco® DC5000, commercially available from Evonik Industries of Parsippany, N.J.

The additive component may further comprise a blocking agent. The blocking agent can be used to delay cream time and increase cure time of the elastomeric polyurethane foam. Suitable blocking agents include any blocking agent known in the art. In a specific embodiment, the blocking agent can be an organic acid, like but limited to 2-ethylhexanoic acid. One skilled in the art typically selects the blocking agent according to the reactivity of the isocyanate component and these blocking agents are typically introduced as an integral part of the selected catalyst.

The isocyanate component and the isocyanate-reactive component can be reacted in the presence of a blowing agent to produce the elastomeric polyurethane foam. As is known in the art, during the elastomeric polyurethane foaming reaction between the isocyanate component and the isocyanate-reactive component, the blowing agent promotes the release of a gas which forms cellular voids in the elastomeric polyurethane foam. The blowing agent can be a physical blowing agent, a chemical blowing agent, or a combination of a physical blowing agent and chemical blowing agent thereof.

The terminology physical blowing agent refers to blowing agents that do not chemically react with the isocyanate component and/or the isocyanate-reactive component to provide the blowing gas. The physical blowing agent can be a gas or liquid. The liquid physical blowing agent typically evaporates into a gas when heated, and evaporates from the resulting elastomeric polyurethane foam when the cells of the foam open. Suitable physical blowing agents for the purposes of the subject disclosure may include liquid carbon dioxide (CO₂), HCFC, HFO's, pentane and all of its isomers, acetone, entrained air, other inert gases, or combinations thereof. The most typical physical blowing agents typically have a zero ozone depletion potential like but not limited to. trans-1-chloro-3,3,3-trifluoropropylene (HCFO-1233zd(E)).

The terminology chemical blowing agent refers to blowing agents which chemically react with the isocyanate component or with other components to release a gas for foaming. Examples of chemical blowing agents that are suitable for the purposes of the subject disclosure include, but are not limited to, formic acid, methyl formate, water, and combinations thereof. The blowing agent is typically present in the isocyanate-reactive component in an amount of from about 0.5 to about 20 parts by weight based on 100 parts by weight of total polyol present in the isocyanate-reactive component.

It must be appreciated that the physical and chemical blowing agents can also be used in combination. Such combinations can include, but are not limited to, water and entrained air.

The isocyanate-reactive component can also include a chain extender. Useful active hydrogen-containing chain extension agents generally contain at least two active hydrogen groups, for example, diols, dithiols, diamines, or compounds having a mixture of hydroxyl, thiol, and amine groups, such as alkanolamines, aminoalkyl mercaptans, and hydroxyalkyl mercaptans, among others. The molecular weight of the chain extenders preferably range from about 60 to about 400. A chain extender, which is a structural unit constituting the polyurethane-based resin, is preferably at least one or more selected from low molecular weight diols and low molecular weight diamines. The chain extender may be a substance having both a hydroxyl group and an amino group in the molecule, such as ethanolamine, propanolamine, butanolamine, and combinations thereof.

Non-limiting examples of suitable diols that may be used as extenders include ethylene glycol and higher oligomers of ethylene glycol including diethylene glycol, triethylene glycol and tetraethylene glycol; propylene glycol and higher oligomers of propylene glycol including dipropylene glycol, tripropylene glycol and tetrapropylene glycol; cyclohexanedimethanol, 1,6-hexanediol, 2-ethyl-1,6-hexanediol, 1,4-butanediol, 2,3-butanediol, 1,5-pentanediol, 1,3-propanediol, butylene glycol, neopentyl glycol, dihydroxyalkylated aromatic compounds such as the bis(2-hydroxyethyl) ethers of hydroquinone and resorcinol; p-xylene-α, α′-diol; the bis(2-hydroxyethyl) ether of p-xylene-α, α′-diol; m-xylene-α, α′-diol and combinations thereof. In a specific embodiment, the chain extender is 1,4-butanediol (BDO).

Non-limiting examples of organic compounds containing at least two aromatic amine groups can be used as aromatic diamine chain extenders having a molecular weight of from 100 to 1,000. The amine chain extenders can contain exclusively aromatically bound primary or secondary (preferably primary) amino groups, and preferably also contain substituents. Examples of such diamines include 1,4-diaminobenzene; 2,4- and/or 2,6-diaminotoluene; 2,4′- and/or 4,4′-diaminodiphenylmethane; 3,3′-dimethyl-4,4′-diaminodiphenylmethane; 3,3′-dichloro-4,4′-diaminodiphenylmethane (MOCA); 3,5-dimethylthiotoluene-2,4- and/or -2,6-diamine; 1,3,5-triethyl-2,4-diaminobenzene; 1,3,5-triisopropyl-2,4-diaminobenzene; 1-methyl-3,5-diethyl-2,4- and/or -2,6-diaminobenzene (also known as 3,5-diethyltoluene-2,4- and/or -2,6-diamine, or DETDA); 4,6-dimethyl-2-ethyl-1,3-diaminobenzene; 3,5,3′,5′-tetraethyl-4,4-diaminodiphenylmethane; 3,5,3′,5′-tetraisopropyl-4,4′-diaminodiphenylmethane; 3,5-diethyl-3′,5′-diisopropyl-4,4′-diaminodiphenylmethane; 2,4,6-triethyl-m-phenylenediamine (TEMPDA); 3,5-diisopropyl-2,4-diaminotoluene; 3,5-di-sec-butyl-2,6-diaminotoluene; 3-ethyl-5-isopropyl-2,4-diaminotoluene; 4,6-diisopropyl-m-phenylenediamine; 4,6-di-tert-butyl-m-phenylenediamine; 4,6-diethyl-m-phenylenediamine; 3-isopropyl-2,6-diaminotoluene; 5-isopropyl-2,4-diaminotoluene; 4-isopropyl-6-methyl-m-phenylenediamine; 4-isopropyl-6-tert-butyl-m-phenylenediamine; 4-ethyl-6-isopropyl-m-phenylenediamine; 4-methyl-6-tert-butyl-m-phenylenediamine; 4,6-di-sec-butyl-m-phenylenediamine; 4-ethyl-6-tertbutyl-m-phenylenediamine; 4-ethyl-6-sec-butyl-m-phenylenediamine; 4-ethyl-6-isobutyl-m-phenylenediamine; 4-isopropyl-6-isobutyl-m-phenylenediamine; 4-isopropyl-6-sec-butyl-m-phenylenediamine; 4-tert-butyl-6-isobutyl-m-phenylenediamine; 4-cyclopentyl-6-ethyl-m-phenylenediamine; 4-cyclohexyl-6-isopropyl-m-phenylenediamine; 4,6-dicyclopentyl-m-phenylenediamine; 2,2′,6,6′-tetraethyl-4,4′-methylenebisaniline; 2,2′,6,6′-tetraisopropyl-4,4′-methylenebisaniline(methylenebis diisopropylaniline); 2,2′,6,6′-tetra-sec-butyl-4,4′-methylenebisaniline; 2,2′-dimethyl-6,6′-di-tert-butyl-4,4′-methylenebisaniline; 2,2′-di-tert-butyl-4,4′-methylenebisaniline; and 2-isopropyl-2′,6′-diethyl-4,4′-methylenebisaniline. Such diamines may, of course, also be used as mixtures.

The isocyanate component and the isocyanate-reactive component are typically reacted at an isocyanate index of greater than or equal to about 90, more typically greater than or equal to about 100. The terminology isocyanate index is defined as the ratio of NCO groups in the isocyanate component to isocyanate-reactive groups in the isocyanate-reactive component multiplied by 100. The elastomeric polyurethane foam of the present disclosure may be produced by mixing the isocyanate component and the isocyanate-reactive component to form a mixture at room temperature or at slightly elevated temperatures, e.g. 15 to 45° C. It certain embodiments in which the elastomeric polyurethane foam is produced in a mold, it is to be appreciated that the isocyanate component and the isocyanate-reactive component may be mixed to form the mixture prior to disposing the mixture in the mold. For example, the mixture may be poured into an open mold or the mixture may be injected into a closed mold. In these embodiments, upon completion of the elastomeric polyurethane foaming reaction, the elastomeric polyurethane foam takes the shape of the mold. The elastomeric polyurethane foam may be produced in, for example, low pressure molding machines, low pressure slabstock conveyor systems, high pressure molding machines, including multi-component machines, high pressure slabstock conveyor systems, and/or by hand mixing. In such embodiments the described materials may be processed, for example may be molded, at temperatures from about 20 to about 70, or from about 20 to about 60° C.

In certain embodiments, the elastomeric polyurethane foam can be produced or disposed in a slabstock conveyor system, which can form elastomeric polyurethane foam having an elongated rectangular or circular shape. As known in the art, slabstock conveyor systems can include mechanical mixing head for mixing individual components, e.g. the isocyanate component and the isocyanate-reactive component, a trough for containing a elastomeric polyurethane foaming reaction, a moving conveyor for elastomeric polyurethane foam rise and cure, and a fall plate unit for leading expanding elastomeric polyurethane foam onto the moving conveyor.

Without intending to be bound by the following theory, the formulations in the instant disclosure result in an improved high temperature compression set performance and maintained exceptional tensile strength, tear strength, elongation at break, and other physical properties. Though not wishing to be bound by any particular theory, it is thought that the resultant elastomeric polyurethane foam has improved qualities because it has a crosslinking density of about 2 to about 3, about 2.1 to about 2.9. about 2.2 to about 2.8, about 2.3 to about 2.6. The average molecular weight between each crosslinking point is about 100 to about 1000 g/mol, about 200 to about 900 g/mol, about 250 to about 650 g/mol, and the polymer assembly is engineered to control the crystallinity of the resultant polymer matrix. This control of the crystallinity is mostly established through selection of the polyol components in the isocyanate-reactive component and isocyanate component.

The density of the elastomeric foam of the present disclosure is between 4 and 40 pounds per cubic foot and can be determined at about 25° C. and 50% relative humidity (RH), in accordance with ASTM D792 method A.

The elastomeric foams of the present disclosure are also evaluated for compression set and compression force deflection (CFD), each in accordance with ASTM D3574. Compression set is a measure of permanent partial loss of original height of the foam after compression due to a bending or collapse of cellular structures within the foam. Compression set is measured by compressing the foam by 90%, i.e., to 10% of original thickness, and holding the foam under such compression at 70 to 150° C. for 22 to about 100 hours. Compression set is expressed as a percentage of original compression. Finally, CFD is a measure of load-bearing performance of the foam and is measured by compressing the foam with a flat compression foot that is larger than the sample. CFD is the amount of force exerted by the flat compression foot and is typically expressed at 25%, 40%, 50%, and/or 65% compression of the foam.

The samples are tested for tensile strength and elongation in accordance with ASTM D3574. Tensile strength and elongation properties describe the ability of the foam to withstand handling during manufacturing or assembly operations. Specifically, tensile strength is the force in lbs/in² required to stretch the foam to a breaking point. Elongation is a measure of the percent that the foam will stretch from an original length before breaking.

The samples are tested for tear strength in accordance with ASTM D3574. Tear strength is the measure of the force required to continue a tear in the elastomeric polyurethane foam after a split or break has been started, and is expressed in lbs/in (ppi).

The Shore A hardness test measures the hardness of the samples in accordance with ASTM D2240. The test is based on the penetration of a specific type of indentor when forced into the material under specified conditions. The indentation hardness is inversely related to the penetration and is dependent on the elastic modulus and viscoelastic behavior of the foam sample.

Reference will now be made to specific examples illustrating the disclosure. It is to be understood that the examples are provided to illustrate exemplary embodiments and that no limitation to the scope of the disclosure is intended thereby.

### EXAMPLES

### Example

### Polyol Blend Examples

A clean vessel is charged with polyol components. The agitation is started and continued throughout the batch procedure. All remaining components except water are sequentially added. The components in the vessel are blended for at least 30 minutes. A sample of the blend is taken and tested for water content via Karl Fischer titration. A calculated amount of water is added to the vessel to achieve desired water level. The blend is then agitated for a minimum of 30 minutes. As shown below in Tables 1 and 2, polyol blend examples 1-14 are made based on this protocol. Table 1 illustrates Group A directed to polyol blend examples 1-8. Table 2 illustrates Group B directed to polyol blend examples 9-14. Group B does not contain polyol D (Pluracol® 2097 polyol) or polyol E (Pluracol® 4156 polyol).

TABLE 1
Formulations of polyol blend examples in Group A.

| | Example | Example | Example | Example | Example | Example | Example | Example |
|---|---|---|---|---|---|---|---|---|
| Polyol Blend Examples | 1 | 2 | 3 | 4 | 5 | 6 | 7 | 8 |
| Polyol A | 40.00 | 40.00 | 40.00 | 34.26 | 31.43 | 22.99 | 40.00 | 40.00 |
| Polyol B | 30.00 | 22.50 | 15.00 | 32.87 | 47.49 | 56.95 | — | — |
| Polyol C | 10.00 | 10.00 | 10.00 | 10.96 | 10.26 | 9.74 | 10.00 | 10.00 |
| Polyol D | 9.65 | 17.15 | 24.65 | 10.65 | — | — | 9.65 | 9.65 |
| Polyol E | — | — | — | — | — | — | 30.00 | — |
| Polyol E* | — | — | — | — | — | — | — | 30.00 |
| Catalyst A | 0.55 | 0.55 | 0.55 | 0.33 | 0.36 | 0.34 | 0.34 | 0.34 |
| Catalyst B | 0.80 | 0.80 | 0.80 | 0.55 | 0.67 | 0.63 | 0.63 | 0.63 |
| Surfactant | 2.00 | 2.00 | 2.00 | 2.19 | 2.18 | 1.95 | 1.95 | 1.95 |
| Chain Extender | 7.00 | 7.00 | 7.00 | 7.67 | 7.18 | 6.82 | 6.82 | 6.82 |
| Blowing agent | 0.55 | 0.55 | 0.55 | 0.60 | 0.57 | 0.57 | 0.57 | 0.57 |
| Equivalent weight | 337.47 | 339.15 | 340.84 | 312.91 | 328.94 | 336.00 | 303.38 | — |
| with BDO | | | | | | | | |
| Equivalent weight | 656.60 | 663.45 | 670.44 | 614.80 | 642.11 | 637.65 | 532.03 | — |
| without BDO | | | | | | | | |
| Average functionality | 2.39 | 2.37 | 2.34 | 2.45 | 2.54 | 2.64 | 2.45 | — |
| with BDO | | | | | | | | |
| Average functionality | 2.42 | 2.39 | 2.36 | 2.49 | 2.58 | 2.68 | 2.48 | — |
| without BDO | | | | | | | | |
| Average molecular | 818.19 | 802.58 | 796.92 | 767.06 | 834.40 | 886.10 | 742.22 | — |
| weight with BDO | | | | | | | | |
| Average molecular | 1591.82 | 1588.21 | 1584.53 | 1529.99 | 1655.42 | 1711.35 | 1319.39 | — |
| weight without BDO | | | | | | | | |

Polyol A is Pluracol® 1062 Polyol, which is a propylene oxide or ethylene oxide-capped nominal diol with a number-average molecular weight between about 1000 g/mol and about 9000 g/mol; polyol B is Pluracol® 593 Polyol, which is a nominal triol with a high proportion of randomly dispersed ethoxy groups with a number-average molecular weight between about 1000 g/mol and about 8000 g/mol; polyol C is Lupranol® 2010/1, which is an ethylene oxide-capped nominal tetraol with a number-average molecular weight between about 250 g/mol and about 6000 g/mol; polyol D is Pluracol® 2097 Polyol, which is an ethylene oxide-capped nominal triol with a number-average molecular weight between about 1000 g/mol and about 13000 g/mol; polyol E is Pluracol® 4156 Polyol with a number-average molecular weight at about 5000 g/mol, and polyol E* is Pluracol® 4156 Polyol with a number-average molecular weight at about 12000 g/mol, which is a propylene oxide-capped nominal triol. Catalyst A is Dabco® 8154, which is a blocked tertiary amine; catalyst B is Dabco® 1027, which is a delayed action tertiary amine diluted in ethylene glycol. Surfactant is Dabco® DC5000, which is a non-hydrolysable silicone glycol copolymer. Chain extender is BDO. Blowing agent is water.

TABLE 2
Formulations of polyol blend examples in Group B.

| Polyol blend | Example | Example | Example | Example | Example | Example |
|---|---|---|---|---|---|---|
| examples | 9 | 10 | 11 | 12 | 13 | 14 |
| Polyol A | 59.10 | 56.10 | 53.10 | 38.26 | 39.97 | 53.14 |
| Polyol B | 30.00 | 30.00 | 30.00 | 50.84 | 39.25 | 26.97 |
| Polyol C | — | 3.00 | 6.00 | — | 13.65 | 8.99 |
| Catalyst A | 0.55 | 0.55 | 0.55 | 0.30 | 0.30 | 0.30 |
| Catalyst B | 0.80 | 0.80 | 0.80 | 0.50 | 0.50 | 0.50 |
| Surfactant | 2.00 | 2.00 | 2.00 | 2.00 | 2.00 | 2.00 |
| Chain | 7.00 | 7.00 | 7.00 | 7.00 | 7.00 | 7.00 |
| Extender | | | | | | |
| Blowing | 0.55 | 0.55 | 0.55 | 0.57 | 0.57 | 0.57 |
| agent | | | | | | |
| Equivalent | 339.98 | 339.11 | 338.26 | 338.51 | 349.17 | 344.35 |
| weight | | | | | | |
| with BDO | | | | | | |
| Equivalent | 670.68 | 667.08 | 663.52 | 668.26 | 686.39 | 693.25 |
| weight | | | | | | |
| without BDO | | | | | | |
| Average | 2.10 | 2.17 | 2.23 | 2.36 | 2.50 | 2.28 |
| functionality | | | | | | |
| with BDO | | | | | | |
| Average | 2.11 | 2.18 | 2.25 | 2.38 | 2.53 | 2.30 |
| functionality | | | | | | |
| without BDO | | | | | | |
| Average | 714.91 | 735.47 | 755.93 | 798.02 | 872.12 | 784.42 |
| molecular | | | | | | |
| weight with | | | | | | |
| BDO | | | | | | |
| Average | 1415.51 | 1455.25 | 1494.56 | 1593.48 | 1739.26 | 1593.78 |
| molecular | | | | | | |
| weight | | | | | | |
| without BDO | | | | | | |

When comparing the hydroxyl functionalities of the polyol blend samples, chain extender BDO is taken out of the equation. In general, Group A exhibits higher functionality compared to Group B, due to the higher proportion of polyol C (Lupranol® 2010/1), which is a tetrol. Higher hydroxyl functionality can lead to higher cross-linking density, contributing to an improved high temperature performance.

### Example 2

### Isocyanate Functional Urethane Prepolymer Examples

PMDI (Lupranate® M20) is added into a clean reaction vessel. The agitation is started and continued throughout the operation. The reaction vessel is heated to about 57 to about 63° C. Molten MMDI (Lupranate® M) is then added to the vessel. Polyol is then added at a constant rate over about 30 minutes, the temperature of the reaction mixture is monitored and controlled not to exceed about 80° C. The reaction is allowed to proceed for about 1 hour at about 77 to about 83° C., then cooled to about 25 to about 40° C. and sampled for final analysis. Upon quality control approval, the prepolymer product is transferred to shipping containers using 50 micron filters. As shown in Table 3 below, prepolymer examples 1-4 are made based on the above protocol.

TABLE 3
Formulations of isocyanate functional urethane prepolymers.

| | Prepolymer | Prepolymer | Prepolymer | Prepolymer |
|---|---|---|---|---|
| | example 1 | example 2 | example 3 | example 4 |
| Lupranate ® M20 | 55.04 | 45.04 | 35.04 | 50.24 |
| Luptanate ® M | 36.70 | 46.70 | 56.70 | 31.59 |
| Pluracol 410 | 8.26 | 8.26 | 8.26 | — |
| Polyol A | — | — | — | 18.17 |
| Isocyanate | 2.39 | 2.32 | 2.25 | 2.35 |
| functionality | | | | |

When PMDI (Lupranate® M20) is used in a higher proportion, the prepolymer exhibits a higher isocyanate functionality. Prepolymer samples 1-3 use the same polyol (Pluracol® 410), which is essentially propylene glycol. MMDI (Lupranate® M) is gradually increased to investigate its influence on the foam property. Prepolymer sample 4 uses polyol A (Pluracol® 1062), which is the same polyol used in the foam sample preparation.

### Example 3

### Foam Examples

The drill press is set to a speed of 2340 to 3100 rpm and mix timer is set to 10 to 25 seconds. A mold release agent is applied to an aluminum block mold which is heated to about 35 to 60° C. The typical size of the test block mold is 12″×12″×0.5″ (30.5 cm×30.5 cm×1.3 cm) or 12″×0.25″ (30.5 cm×30.5 cm×0.6 cm). A pre-determined amount of isocyanate-reactive component (resin) is weighed into a mixing cup, and a pre-determined amount of isocyanate componant (ISO) is weighed into a second mixing cup. The prepolymer is poured into the cup containing the resin. The mix blade is then submerged into the mixing cup and mixer is started. After mixing for the set time, the reacting foam is poured from the mixing cup into the mold, and the mold is closed. After about 4 to about 7 minutes, the mold is opened and the foam block is removed. As shown below in Tables 4 and 5, elastomeric polyurethane foam examples 1-17 are made based on the above protocol. Foams made with only Pluracol 1062 polyol or Pluracol® 593 polyol have very poor properties, in some cases the foam may not even be stable enough to rise.

TABLE 4
Physical properties of the elastomeric polyurethane foams from Group A polyol blend.

| | Foam | Foam | Foam | Foam | Foam | Foam | Foam | Foam | Foam | Foam | Foam |
|---|---|---|---|---|---|---|---|---|---|---|---|
| Foam | Example | Example | Example | Example | Example | Example | Example | Example | Example | Example | Example |
| Examples | 1 | 2 | 3 | 4 | 5 | 6 | 7 | 8 | 9 | 10 | 11 |
| Prepolymer | 1 | 1 | 1 | 4 | 4 | 4 | 4 | 2 | 3 | 1 | 1 |
| examples | | | | | | | | | | | |
| Polyol blend | 1 | 2 | 3 | 4 | 1 | 5 | 6 | 1 | 1 | 7 | 8 |
| examples | | | | | | | | | | | |
| Density (lb/ft³) | 26.9 | 25.4 | 25.6 | 25.6 | 26.6 | 24.9 | 25.8 | 27.2 | 26.9 | 23.1 | 22.8 |
| Tensile (psi) | 163.4 | 169.7 | 173.5 | 128.2 | — | 108.9 | 84.3 | 131.9 | 131.4 | 166.4 | 282.5 |
| Tensile after | 156.9 | 178.2 | 175.1 | 171.9 | — | 108.7 | 81.8 | 140.7 | 127.0 | 158.1 | 274.0 |
| aging at 102° C. | | | | | | | | | | | |
| for 70 h (psi) | | | | | | | | | | | |
| Tensile after | −4.0 | 5.0 | 0.9 | 34.1 | — | −0.3 | −2.9 | 6.7 | −3.3 | −5.0 | −3.0 |
| aging at 102° C. | | | | | | | | | | | |
| for 70 h | | | | | | | | | | | |
| (change, %) | | | | | | | | | | | |
| Tensile after | 132.4 | 170.7 | 175.1 | 125.0 | — | 97.6 | 76.4 | 124.1 | 105.0 | 154.8 | 259.9 |
| aging at 60° C. | | | | | | | | | | | |
| for 168 h (psi) | | | | | | | | | | | |
| Tensile after | −19.0 | 0.6 | 0.9 | −2.5 | — | −10.4 | −9.3 | −5.9 | −20.1 | −7.0 | −8.0 |
| aging at 60° C. | | | | | | | | | | | |
| for 168 h | | | | | | | | | | | |
| (change, %) | | | | | | | | | | | |
| Elongation (%) | 113 | 81 | 70 | 97 | — | 86 | 58 | 107 | 124 | 70 | 72 |
| Elongation after | 114 | 86 | 72 | 118 | — | 83 | 54 | 116 | 126 | 67 | 64 |
| aging at 102° C. | | | | | | | | | | | |
| for 70 h (%) | | | | | | | | | | | |
| Elongation after | 1.0 | 6.0 | 3.0 | 21.5 | — | −3.5 | −7.1 | 8.3 | 1.7 | −4.0 | −11.0 |
| aging at 102° C. | | | | | | | | | | | |
| for 70 h | | | | | | | | | | | |
| (change %) | | | | | | | | | | | |
| Elongation after | 97 | 88 | 76 | 100 | — | 72 | 47 | 105 | 106 | 68 | 74 |
| aging at 60° C. | | | | | | | | | | | |
| for 168 h (%) | | | | | | | | | | | |
| Elongation after | −14.0 | 8.8 | 8.6 | 3.1 | — | −16.8 | −19.7 | −1.4 | −14.1 | −3.0 | 3.0 |
| aging at 60° C. | | | | | | | | | | | |
| for 168 h | | | | | | | | | | | |
| (change, %) | | | | | | | | | | | |
| Tear (lbf/in) | 21.5 | 22.9 | 20.3 | 20.4 | — | 16.6 | 13.6 | 21.8 | 22.0 | 19.2 | 39.4 |
| Tear after aging | 25.4 | 25.9 | 21.7 | 23.4 | — | 17.3 | 15.7 | 23.0 | 23.9 | 20.4 | 37.4 |
| at 102° C. for 70 h | | | | | | | | | | | |
| (lbf/in) | | | | | | | | | | | |
| Tear after aging | 18.0 | 13.0 | 7.0 | 14.9 | — | 4.7 | 14.9 | 5.6 | 8.7 | 6.0 | −5.0 |
| at 102° C. for 70 h | | | | | | | | | | | |
| (change, %) | | | | | | | | | | | |
| Tear after aging | 23.2 | 23.3 | 18.8 | 14.0 | — | 14.6 | 10.9 | 18.2 | 18.2 | 19.0 | 37.0 |
| at 60° C. for 168 h | | | | | | | | | | | |
| (lbf/in) | | | | | | | | | | | |
| Tear after aging | 7.9 | 1.6 | −7.6 | −31.3 | — | −12.1 | −19.8 | −16.6 | −17.1 | −1.0 | −6.0 |
| at 60° C. for 168 h | | | | | | | | | | | |
| (change, %) | | | | | | | | | | | |
| Shore A Hardness | 29 | 35 | 36 | 29 | — | 21 | 28 | 25 | 25 | 34 | 54 |
| Shore A | 37 | 40 | 40 | 36 | — | 27 | 31 | 33 | 28 | 41 | 54 |
| Hardness after | | | | | | | | | | | |
| aging at 102° C. | | | | | | | | | | | |
| for 70 h | | | | | | | | | | | |
| Shore A | 8 | 5 | 4 | 7 | — | 6 | 3 | 8 | 3 | 7 | 10 |
| Hardness after | | | | | | | | | | | |
| aging at 102° C. | | | | | | | | | | | |
| for 70 h | | | | | | | | | | | |
| (change, %) | | | | | | | | | | | |
| Shore A | 23 | 25 | 26 | 25 | — | 21 | 11 | 24 | 23 | 33 | 49 |
| Hardness after | | | | | | | | | | | |
| aging at 60° C. | | | | | | | | | | | |
| for 168 h | | | | | | | | | | | |
| Shore A | −6 | −10 | −8 | −4 | — | 0 | −17 | −1 | −2 | −1 | −5 |
| Hardness after | | | | | | | | | | | |
| aging at 60° C. | | | | | | | | | | | |
| for 168 h | | | | | | | | | | | |
| (change, %) | | | | | | | | | | | |
| Compression | 2.8 | 2.2 | 3 | — | — | — | — | — | — | 5.7 | 32.9 |
| Set, 50% after | | | | | | | | | | | |
| 68° C. for 22 h | | | | | | | | | | | |
| Compression | — | — | — | — | — | 3.6 | 3.6 | — | — | — | — |
| Set, 40% after | | | | | | | | | | | |
| 68° C. for 96 h | | | | | | | | | | | |
| Compression | — | — | — | — | — | 13.9 | 13.6 | — | — | — | — |
| Set, 40% after | | | | | | | | | | | |
| 100° C. for 96 h | | | | | | | | | | | |
| Compression | 28 | 27.1 | 37.4 | 26.1 | 29.8 | 5.2 | 2.7 | 27.8 | 30.4 | 25.6 | 33.7 |
| Set, 40% after | | | | | | | | | | | |
| 110° C. for 96 h | | | | | | | | | | | |
| Compression | 37.6 | — | — | 38.3 | 39.0 | 40.8 | 40.3 | 39.7 | 38.5 | 43.6 | 42.0 |
| Set, 40% after | | | | | | | | | | | |
| 120° C. for 96 h | | | | | | | | | | | |
| Compression | 30.0 | — | — | 40.4 | 41.1 | 43.1 | 44.3 | 40.4 | 40.6 | 43.5 | 44.0 |
| Set, 40% after | | | | | | | | | | | |
| 130° C. for 96 h | | | | | | | | | | | |
| Compression | 50.3 | — | — | 45.4 | 43.2 | 40.1 | 40.6 | 43.9 | 42.9 | 45.1 | 44.6 |
| Set, 40% after | | | | | | | | | | | |
| 140° C. for 96 h | | | | | | | | | | | |
| Compression | 45.4 | — | — | 45.5 | 43.3 | 42.7 | 41.8 | 44.0 | 39.9 | 46.8 | 44.9 |
| Set, 40% after | | | | | | | | | | | |
| 150° C. for 96 h | | | | | | | | | | | |
| 25% CFD (psi) | — | — | — | — | — | 19.4 | 22.1 | — | — | — | — |
| 25% CFD after | — | — | — | — | — | 18.7 | 21.2 | — | — | — | — |
| aging at 102° C. | | | | | | | | | | | |
| for 70 h (psi) | | | | | | | | | | | |
| % of ambient | — | — | — | — | — | 96.1 | 96.0 | — | — | — | — |
| 25% CFD | | | | | | | | | | | |
| 50% CFD (psi) | — | — | — | — | — | 48.5 | 50.7 | — | — | — | — |
| 50% CFD after | — | — | — | — | — | 47.0 | 49.4 | — | — | — | — |
| aging at 102° C. | | | | | | | | | | | |
| for 70 h (psi) | | | | | | | | | | | |
| % of ambient | — | — | — | — | — | 96.8 | 97.5 | — | — | — | — |
| 50% CFD | | | | | | | | | | | |
| Heat aging at | — | — | — | — | — | 2.1 | 2.7 | — | — | — | — |
| 102° C. for 7 h | | | | | | | | | | | |
| for compression | | | | | | | | | | | |
| set 40% after 68° C. | | | | | | | | | | | |
| for 96 h | | | | | | | | | | | |

TABLE 5
Physical properties of the elastomeric polyurethane foams from Group B polyol blend.

| | Foam | Foam | Foam | Foam | Foam | Foam |
|---|---|---|---|---|---|---|
| | Example | Example | Example | Example | Example | Example |
| Foam Examples | 12 | 13 | 14 | 15 | 16 | 17 |
| Prepolymer | 1 | 1 | 1 | I | 1 | 2 |
| Polyol blend examples | 9 | 10 | 11 | 12 | 13 | 14 |
| Density (lb/ft³) | 26.7 | 27.8 | 27.7 | 29.8 | 32.2 | 30.8 |
| Tensile (psi) | 165.7 | 163.6 | 149.9 | 80.4 | 97.9 | 130.5 |
| Tensile after aging at 102° C. | 167.4 | 184.9 | 161.9 | 81.0 | 146.4 | 123.2 |
| for 70 h (psi) | | | | | | |
| Tensile after aging at 102° C. | 1.0 | 13.0 | 8.0 | 0.7 | 49.5 | −5.6 |
| for 70 h (change, %) | | | | | | |
| Tensile after aging at 60° C. | 197.2 | 193.0 | 194.9 | 63.6 | 121.1 | 125.8 |
| for 168 h (psi) | | | | | | |
| Tensile after aging at 60° C. | 19.0 | 18.0 | 30.0 | −20.1 | 23.7 | −3.6 |
| for 168 h (change, %) | | | | | | |
| Elongation (%) | 124 | 107 | 116 | 74 | 70 | 106 |
| Elongation after aging at | 123 | 116 | 113 | 68 | 118 | 104 |
| 102° C. for 70 h (%) | | | | | | |
| Elongation after aging at | −1.0 | 8.0 | −3.0 | −8.1 | 68.6 | −1.9 |
| 102° C. for 70 h (change, %) | | | | | | |
| Elongation after aging at 60° C. | 136 | 117 | 119 | 88 | 95 | 104 |
| for 168 h (%) | | | | | | |
| Elongation after aging at 60° C. | 10.0 | 9.0 | 3.0 | 18.9 | 35.7 | −1.9 |
| for 168 h (change, %) | | | | | | |
| Tear (lbf/in) | 29.2 | 25.1 | 24.1 | 13.2 | 19.3 | 20.9 |
| Tear after aging at 102° C. | 23.4 | 24.3 | 22.9 | 15.1 | 19.0 | 24.5 |
| for 70 h (lbf/in) | | | | | | |
| Tear after aging at 102° C. | −20.0 | −3.0 | −5.0 | 14.4 | −1.6 | 17.2 |
| for 70 h (change, %) | | | | | | |
| Tear after aging at 60° C. | 27.2 | 22.3 | 23.6 | 14.1 | 19.8 | 22.6 |
| for 168 h (lbf/in) | | | | | | |
| Tear after aging at 60° C. | −7.0 | −11.0 | −2.0 | 6.8 | 2.6 | 8.1 |
| for 168 h (change, %) | | | | | | |
| Shore A Hardness | 30 | 32 | 33 | 26 | 31 | 31 |
| Shore A Hardness after | 40 | 42 | 44 | 26 | 34 | 37 |
| aging at 102° C. for 70 h | | | | | | |
| Shore A Hardness after | 10 | 10 | 11 | 0 | 3 | 6 |
| aging at 102° C. for 70 h | | | | | | |
| (change, %) | | | | | | |
| Shore A Hardness after | 25 | 26 | 28 | 27 | 28 | 25 |
| aging at 60° C. for 168 h | | | | | | |
| Shore A Hardness after | −5 | −6 | −5 | 1 | −3 | −6 |
| aging at 60° C. for 168 h | | | | | | |
| (change, %) | | | | | | |
| Compression Set, 50% after | 1.8 | 2.2 | 2.4 | — | — | — |
| 68° C. for 22 h | | | | | | |
| Compression Set, 40% after | — | — | — | 1.6 | 3.4 | 4.5 |
| 68° C. for 96 h | | | | | | |
| Compression Set, 40% after | — | — | — | 12.1 | 13.3 | 22.7 |
| 100° C. for 96 h | | | | | | |
| Compression Set, 40% after | — | — | — | 27.6 | 13.3 | 22.7 |
| 110° C. for 9611 | | | | | | |
| Compression Set, 40% after | — | — | — | 37.0 | 35.3 | 39.6 |
| 120° C. for 96 h | | | | | | |
| Compression Set, 40% after | — | — | — | 40.2 | 38.8 | 43.3 |
| 130° C. for 96 h | | | | | | |
| Compression Set, 40% after | — | — | — | 40.4 | 37.0 | 39.6 |
| 140° C. for 96 h | | | | | | |
| Compression Set, 40% after | — | — | — | 44.1 | 42.7 | 43.9 |
| 150° C. for 96 h | | | | | | |
| 25% COD (psi) | — | — | — | 15.6 | 18.9 | 20.2 |
| 25% CFD after aging at 102° C. | — | — | — | 14.8 | 18.6 | 19.8 |
| for 70 h (psi) | | | | | | |
| % of ambient 25% CFD | — | — | — | 94.8 | 98.7 | 98.2 |
| 50% CFD (psi) | — | — | — | 39.1 | 49.0 | 49.3 |
| 50% CFD after aging at 102° C. | — | — | — | 37.3 | 48.6 | 48.5 |
| for 70 h (psi) | | | | | | |
| % of ambient 50% CFD | — | — | — | 95.4 | 99.2 | 98.3 |
| Heat aging at 102° C. for 7 h | — | — | — | 3.4 | 1.7 | 4.0 |
| for compression set 40% | | | | | | |
| after 68° C. for 96 h | | | | | | |

As shown in Tables 4 and 5, the constant deflection compression set value at 40% deflection of the elastomeric polyurethane foam in the instant disclosure is less than about 40% even when the foam sample is compressed at stringent conditions such as 100° C. to 130° C. for 96 hours. The tensile strength value of the elastomeric polyurethane foam in the instant disclosure is about 50 lbf/in² to about 285 lbf/in². The tear strength value is about 13 lbf/in to about 40 lbf/in. The elongation at break value is about 50% to about 160%.

Two different aging conditions, exposure to 102° C. for 70 h and exposure to 60° C. and 95% relative humidity for 168 h are used to determine the foam property. Tensile strength, elongation, tear strength, and Shore A hardness are tested before and after aging. When aged at 102° C. for 70 h, the tensile strength value of the elastomeric polyurethane foam in the instant disclosure undergoes about less than 50% change, the tear strength value undergoes about less than 30% change, the elongation at break value undergoes about less than 50% change. When aged at 60° C. and 95% relative humidity for 168 h, the tensile strength value of the elastomeric polyurethane foam in the instant disclosure undergoes about less than 35% change, the tear strength value undergoes about less than 35% change, the elongation at break value undergoes about less than 35% change. The small properties changes at different aging conditions corroborate the improved high temperature performance of the elastomeric polyurethane foams disclosed herein.

TABLE 6
Formulations of isocyanate functional urethane prepolymers.

| | Prepolymer | Prepolymer |
|---|---|---|
| | example 5 | example 6 |
| | Elastofoam | Elastofoam |
| | 24050T | MP102 |
| Lupranate ® M20 | 55.04 | — |
| Lupranate ® M | 36.70 | 87.2 |
| Pluracol ® 410 | 8.26 | 4.8 |
| Polyol A | — | 8 |
| Isocyanate | ~2.42 | 2 |
| functionality | | |

TABLE 7
Physical properties of the elastomeric polyurethane
foams from a blend of
prepolymers.

| | Foam | Foam | Foam | Foam |
|---|---|---|---|---|
| | Example | Example | Example | Example |
| Foam Examples | 18 | 19 | 20 | 21 |
| Prepolymer | 5 | 5/6 | 5/6 | 5/6 |
| | | 90/10 | 80/20 | 70/30 |
| Polyol blend examples | 9 | 9 | 9 | 9 |
| Density (lb/ft³) | 22.4 | 22.5 | 22.3 | 21.4 |
| Tensile (psi) | 154.2 | 177.2 | 165.5 | 196.0 |
| Tensile after aging at | 170.7 | 164.2 | 188.3 | 182.1 |
| 102° C. for 70 h (psi) | | | | |
| Tensile after aging at | 10.7 | −7.3 | 13.8 | −7.1 |
| 102° C. for 70 h | | | | |
| (change, %) | | | | |
| Tensile after aging at | 155.3 | 176.9 | 163.7 | 18.6 |
| 60° C. @ 100% RH for | | | | |
| 168 h (psi) | | | | |
| Tensile after aging at | 0.7 | −0.2 | −1.1 | −7.9 |
| 60° C. @ 100% RH for | | | | |
| 168 h | | | | |
| (change, %) | | | | |
| Elongation (%) | 123.3 | 137.9 | 140.1 | 158.6 |
| Elongation after aging at | 137.6 | 142.0 | 170.1 | 173.2 |
| 102° C. for 70 h (%) | | | | |
| Elongation after aging at | 11.6 | 3.0 | 21.4 | 9.2 |
| 102° C. for 70 h | | | | |
| (change %) | | | | |
| Elongation after aging at | 136.0 | 161.9 | 158.4 | 175.6 |
| 60° C. for 168 h (%) | | | | |
| Elongation after aging at | 10.3 | 17.4 | 13.1 | 10.7 |
| 60° C. for 168 h | | | | |
| (change, %) | | | | |
| Tear (lbf/in) | 24.0 | 27.8 | 30.2 | 29.6 |
| Tear after aging at | 25.7 | 27.8 | 2.4 | 29.2 |
| 102° C. | | | | |
| for 70 h (lbf/in) | | | | |
| Tear after aging at | 7.1 | 0.0 | −2.6 | −1.4 |
| 102° C. | | | | |
| for 70 h | | | | |
| (change, %) | | | | |
| Tear after aging at 60° C. | 21.8 | 23.9 | 26.8 | 28.8 |
| @ 100% RH for 168 h | | | | |
| (lbf/in) | | | | |
| Tear after aging at 60° C. | −9.2 | −14.0 | −11.3 | −2.7 |
| @ 100% RH for 168 h | | | | |
| (change, %) | | | | |
| Shore A Hardness | 10.3 | 10.3 | 9.7 | 9.7 |
| Shore A Hardness after | 11.3 | 11.0 | 10.0 | 9.7 |
| aging at 102° C. for 70 h | | | | |
| Shore A Hardness after | 9.7 | 6.8 | 3.1 | 0.0 |
| aging at 102° C. for 70 h | | | | |
| (change, %) | | | | |
| Shore A Hardness after | 10.7 | 9.0 | 8.7 | 8.7 |
| aging at 60° C. @ 100% | | | | |
| RH for 168 h | | | | |
| Shore A Hardness after | 3.9 | −12.6 | −10.3 | −10.3 |
| aging at 60° C. @ 100% | | | | |
| RH for 168 h | | | | |
| (change, %) | | | | |
| Compression Set, 50% | 2.3 | 1.7 | 1.9 | 1.7 |
| after 158° F. for 22 h | | | | |
| Compression Set, 50% | 8.8 | 9.3 | 8.5 | 7.1 |
| after 210° F. for 22 h | | | | |
| Compression Set, 40% | 36.5 | 37.7 | 39.1 | 39.9 |
| after 110° C. for 96 h | | | | |
| Compression Set, 40% | 41.7 | 41.5 | 38.7 | 42.5 |
| after 120° C. for 96 h | | | | |
| Compression Set, 40% | 40.4 | 42.0 | 41.5 | 41.5 |
| after 130° C. for 96 h | | | | |
| Compression Set, 40% | 43.4 | 44.3 | 42.9 | 45.4 |
| after 140° C. for 96 h | | | | |
| Compression Set, 40% | 40.9 | 42.3 | 41.4 | 42.6 |
| after 150° C. for 96 h | | | | |
| 25% CFD (psi) | 10.5 | 10.7 | 10.8 | 8.7 |
| 25% CFD after aging at | 10.1 | 10.2 | 10.8 | 8.5 |
| 102° C. for 70 h (psi) | | | | |
| % of ambient 25% CFD | −3.8 | −4.7 | 0.0 | −2.3 |
| 50% CFD (psi) | 31.5 | 35.5 | 29.3 | 22.7 |
| 50% CFD after aging at | 29.0 | 32.7 | 29.8 | 22.3 |
| 102° C. for 70 h (psi) | | | | |
| % of ambient 50% CFD | −7.9 | −7.9 | 1.7 | −1.8 |
| Heat aging at 102° C. for | 0.74 | 0.75 | 1.20 | 1.30 |
| 70 h for compression set | | | | |
| 40% after 158° F. for 22 h | | | | |

Those skilled in the art will recognize, or be able to ascertain, using no more than routine experimentation, numerous equivalents to the specific composition and procedures described herein. Such equivalents are considered to be within the scope of this disclosure, and are covered by the following claims.

1. An elastomeric polyurethane foam with improved high temperature compression set values, comprising a reaction product of components comprising:
(a) an isocyanate functional urethane prepolymer derived from one or more prepolymers comprising monomeric diphenylmethane diisocyanate (MMDI) or polymeric MDI (PMDI), and a polyether diol; and
(b) an isocyanate-reactive component comprising:
(i) a first polyol in the amount of about 10 to about 70 parts by weight of the isocyanate-reactive component, wherein the first polyol is a propylene oxide or ethylene oxide-capped nominal diol with a number-average molecular weight between about 1000 g/mol and about 9000 g/mol,
(ii) a second polyol in the amount of about 0 to about 50 parts by weight of the isocyanate-reactive component, wherein the second polyol is a nominal triol with a high proportion of randomly dispersed ethoxy groups with a number-average molecular weight between about 1000 g/mol and about 8000 g/mol,
(iii) a third polyol in the amount of about 0 to about 20 parts by weight of the isocyanate-reactive component, wherein the third polyol is an ethylene oxide-capped nominal tetraol with a number-average molecular weight between about 250 g/mol and about 6000 g/mol, and
(iv) a fourth polyol in the amount of about 0 to about 80 parts by weight of the isocyanate-reactive component, wherein the fourth polyol is an ethylene oxide or propylene oxide-capped nominal triol with a number-average molecular weight between about 1000 g/mol and about 13000 g/mol;
wherein at least one of components (ii), (iii), and (iv) are present at more than about 0 parts by weight.

2. The elastomeric polyurethane foam of claim 1, wherein the first polyol comprises about 30 to about 70 parts, 35 to about 65 parts, 0 to about 45 parts, 15 to about 40 parts, 0 to about 15 parts, 0 to about 10 parts, 0 to about 30 parts, or 0 to about 15 parts by weight of the isocyanate-reactive component.

3. (canceled)

4. (canceled)

5. (canceled)

6. (canceled)

7. (canceled)

8. (canceled)

9. (canceled)

10. The elastomeric polyurethane foam of claim 1, wherein the first polyol has a number-average molecular weight of about 6000 g/mol and a functionality of 1.5 to 2.0, wherein the second polyol has a number-average molecular weight of about 3600 g/mol and a functionality of 2.8 to 3.0, wherein the third polyol has a number-average molecular weight of about 5250 g/mol and a functionality of 3.5 to 5.0, and/or wherein the fourth polyol has a number-average molecular weight of about 2800 to about 6000 g/mol and a functionality of 2.1 to 3.0.

11. (canceled)

12. (canceled)

13. (canceled)

14. The elastomeric polyurethane foam of claim 1, wherein the isocyanate-reactive component further comprises an additive package in an amount of about 1 to about 30 parts by weight of the isocyanate-reactive component, the additive package comprises a component selected from a blowing agent, a catalyst, a coloring agent, dyes, pigments, cross-linkers, flame retardant, diluents, solvents, an inorganic filler, catalysts, antioxidants, ultraviolet stabilizers, biocides, adhesion promoters, antistatic agents, mold release agents, fragrances and any combination thereof.

15. The elastomeric polyurethane foam of claim 1, wherein the isocyanate-reactive component further comprises a surfactant in the amount of about 0 to about 5 parts by weight of isocyanate-reactive component.

16. The elastomeric polyurethane foam of claim 14, wherein the surfactant is Dabco® DC5000.

17. The elastomeric polyurethane foam of claim 1, wherein the isocyanate-reactive component further comprises a chain extender in an amount of about 0 to about 10 parts by weight of the isocyanate-reactive component.

18. The elastomeric polyurethane foam of claim 17, wherein the chain extender is 1,4-butanediol.

19. The elastomeric polyurethane foam of claim 1, wherein the isocyanate-reactive component further comprises a chemical blowing agent in an amount of about 0.1 to about 4 parts by weight of the isocyanate-reactive component.

20. The elastomeric polyurethane foam of claim 19, wherein the chemical blowing agent is water.

21. The elastomeric polyurethane foam of claim 1, wherein the isocyanate-reactive component further comprises a physical blowing agent in an amount of about 0 to 12 parts by weight of the isocyanate reactive component.

22. The elastomeric polyurethane foam of claim 21, wherein the physical blowing agent is HCFO-1233zd(E).

23. The prepolymer of claim 1, wherein the MMDI is in an amount of about 20 to about 70 parts, wherein the PMDI is in an amount of about 20 to about 70 parts, wherein the polyether diol is in an amount of about 5 to about 30 parts, and/or wherein the polyether diol is in an amount of about 5 to about 30 parts.

24. (canceled)

25. (canceled)

26. (canceled)

27. The prepolymer of claim 1, wherein the PMDI has a viscosity from about 150 to about 850 cps at 25° C. and a percent NCO from about 30 to about 32.5.

28. The prepolymer of claim 1, wherein the polyether diol has a number-average molecular weight of about 425 g/mol, and a functionality of 1.75 to 2.0 or a number-average molecular weight of about 6000 g/mol and a functionality of 1.5 to 2.0.

29. The elastomeric polyurethane foam of claim 1, wherein the compression set value of the foam comprises a constant deflection at about 30% to about 50% deflection according to ASTM D3574 is less than about 40% M the foam sample is compressed at about 70° C. to about 150° C. for about 22 to about 100 hours, and/or wherein the constant deflection compression set value of the foam at about 30% to about 50% deflection according to ASTM D3574 is less than about 40% when the foam sample is compressed at about 100° C. to about 130° C. for about 22 to about 100 hours.

30. (canceled)

31. The elastomeric polyurethane foam of claim 1, wherein the tensile strength value of the foam according to ASTM D3574 is about 50 lbf/in² to about 285 lbf/in², wherein the tear strength value of the foam according to ASTM D3574 is about 13 lbf/in to about 40 lbf/in, and/or wherein the elongation at break value of the foam according to ASTM D3574 is about 50% to about 160%.

32. (canceled)

33. (canceled)

34. The elastomeric polyurethane foam of claim 1, wherein the tensile strength value of the foam according to ASTM D3574 undergoes about less than 50% change when the foam is aged at about 102° C. for about 70 hours, wherein the tear strength value of the foam according to ASTM D3574 undergoes about less than 30% change when the foam is aged at about 102° C. for about 70 hours, and/or wherein the elongation at break value of the foam according to ASTM D3574 undergoes about less than 50% change when the foam is aged at about 102° C. for about 70 hours.

35. (canceled)

36. (canceled)

37. The elastomeric polyurethane foam of claim 1, wherein the tensile strength value of the foam according to ASTM D3574 undergoes about less than 35% change when the foam is aged at about 60° C. and about 95% relative humidity for about 168 hours, wherein the tear strength value of the foam according to ASTM D3574 undergoes about less than 35% change when the foam is aged at about 60° C. and about 95% relative humidity for about 168 hours, and/or wherein the elongation at break value of the foam according to ASTM D3574 undergoes about less than 35% change when the foam is aged at about 60° C. and about 95% relative humidity for about 168 hours.

38. (canceled)

39. (canceled)

40. A method of forming an elastomeric polyurethane foam, the method comprising the steps of:
(a) reacting a prepolymer with a polyether diol to form an isocyanate functional urethane prepolymer wherein the prepolymer comprises an MMDI and/or a PMDI;
(b) blending at least a first polyol, a second polyol, a third polyol, and a fourth polyol to form an isocyanate-reactive component; and
(c) mixing the isocyanate prepolymer and the isocyanate-reactive component at about 100 isocyanate index to about 110 isocyanate index to form the elastomeric polyurethane foam,
wherein the first polyol is a propylene oxide or ethylene oxide-capped nominal diol with a number-average molecular weight between about 1000 g/mol and about 9000 g/mol that comprises about 10 to about 70 parts by weight of the isocyanate-reactive component,
the second polyol is a nominal triol that has a high proportion of randomly dispersed ethoxy groups with a number-average molecular weight between about 1000 g/mol and about 8000 g/mol and comprises about 0 to about 50 parts by weight of the isocyanate-reactive component,
the third polyol is an ethylene oxide-capped nominal tetraol with a number-average molecular weight between about 250 g/mol and about 6000 g/mol and comprises about 0 to about 15 parts by weight of the isocyanate-reactive component, and
the fourth polyol is an ethylene oxide or propylene oxide-capped nominal triol with a number-average molecular weight of about 1000 g/mol and about 13000 g/mol and comprises about 0 to about 80 parts by weight of the isocyanate-reactive component.

41. (canceled)
